(19) United States
(12) Patent Application Publication
(10) Pub. No.: US 2026/0249921 A1
(43) Pub. Date: Aug. 27, 2026

(54) WATERPROOF STRUCTURE FOR FRONT PILLAR OF VEHICLE

(71) Applicants: Hyundai Motor Company, Seoul (KR); Kia Corporation, Seoul (KR)

(72) Inventor: Song-Jae Jeong, Hwaseong-si (KR)

(21) Appl. No.: 19/259,311

(22) Filed: Jul. 3, 2025

(30) Foreign Application Priority Data
Feb. 21, 2025 (KR) 10-2025-0022849

(51) Int. Cl. B62D 25/04; B62D 25/08

(52) U.S. Cl. CPC B62D 25/04; B62D 25/081

(57) ABSTRACT

A water deflecting structure of a front pillar can include a side outer panel having a side-outer-panel upper side configured to be disposed at a windshield-glass lower side of a periphery of a windshield glass, and a flat drainage surface having a first angle with respect to a ground at the side-outer-panel upper side of the side outer panel and configured to be adjacent the periphery of the windshield glass. A waterproof front pillar structure of a vehicle can include a side outer panel having a flat drainage surface with a first length at a first angle with respect to a ground, and a front pillar outer lower reinforce coupled to and underlapping the side outer panel, where the front pillar outer lower reinforce has an inclined surface in contact with the flat drainage surface of the side outer panel.

### CROSS-REFERENCE TO RELATED APPLICATIONS

This application claims priority to Korean Patent Application No. 10-2025-0022849, filed on Feb. 21, 2025, which is incorporated herein by reference in its entirety.

### TECHNICAL FIELD

The present disclosure relates to a waterproof structure of a front pillar of a vehicle.

### BACKGROUND

During raining or washing of a vehicle 100, water flows downward along a windshield glass 111 on a surface of the windshield glass 111 of the vehicle 100.

In particular, when a driver operates a wiper 112 to secure a field of view, water on a windshield glass 111 is collected to side surfaces of the windshield glass 111 and flows downward along a front pillar outer panel 113 forming an outer surface of a front pillar.

In prevention of the water flowing along the front pillar outer panel 113 into the vehicle 100, a portion in which a lower end of the windshield glass 111 meets the front pillar (a portion indicated as “A” in FIG. 1) is double-sealed using a paint sealer and a structural adhesive, thereby improving waterproof performance.

However, the portion in which the lower end of the windshield glass 111 meets the front pillar is not easily coated with the paint sealer due to a hood 114 and a fender 115 of a vehicle 100.

For waterproof, the paint sealer needs to be coated along a line indicated as the dotted line in FIG. 2, but the hood 114 and the fender 115 interfere with a robot moving along a coating line of the paint sealer, and thus the paint sealer cannot be coated in some sections.

The section in which the paint sealer cannot be coated by the robot needs to be sealed using only the structural adhesive compared to the sealing that the paint sealer and the structural adhesive are double-coated, thereby degrading sealing performance. Because it is more difficult for the structural adhesive to fill a step portion between components than the paint sealer, the increased amount of the structural adhesive is coated. In this way, because a large amount of the structural adhesive needs to be coated, production cost also increases.

An assembly relationship of a panel constituting the portion in which the lower end of the windshield glass 111 comes into contact with the front pillar outer panel 113 also had limitations in increasing waterproof performance. As illustrated in FIG. 3, a water drop (W) or raindrop pushed by the wiper 112 and drained from the windshield glass 111 flows along an upper curved surface of an assembly of a front pillar outer lower reinforce 122 and a side outer panel 121. In a portion in which a surface on which the windshield glass 111 is disposed and the side surfaces of the vehicle 100 are connected (a portion indicated as “B” in FIG. 2 and shown in FIG. 3), the front pillar outer lower reinforce 122 and the side outer panel 121 do not come into close contact, and a space (gap), or an assembly tolerance occurs. Accordingly, even when the paint sealer or the structural adhesive is provided, water is introduced through the space between the front pillar outer lower reinforce 122 and the side outer panel 121. That is, in the section in which the step portion between components occurs due to the assembly tolerance, the paint sealer and the structural adhesive need to be double-coated to secure watertightness, but in the section in which the paint sealer is not coated, the space between the front pillar outer lower reinforce 122 and the side outer panel 121 is not waterproof due to the tolerance or the step portion, and water may be introduced into the vehicle 100.

In addition, because an upper end of the side outer panel 121 is formed in a rounded shape, a flow rate of the water decreases, thereby increasing the time for the water to remain and increasing the possibility of water penetration.

In addition, because an upper end of a side surface of a cowl side upper outer panel 123 assembled between the front pillar outer lower reinforce 122 and the side outer panel 121 is formed in a direction horizontal to the ground, water moves therealong, causing water to penetrate a space between the panels or the vehicle 100.

In this way, there is a problem that the panels are corroded as the water introduced from the windshield glass 111 to the front pillar outer panel 113 penetrates the space between the panels around the front pillar.

### SUMMARY

The present disclosure relates to a waterproof structure of a front pillar, which prevents water from flowing into a vehicle through a location at which the front pillar of a vehicle meets a lower side of a windshield glass.

An embodiment of the present disclosure can provide a waterproof structure of a front pillar in which it can be possible to improve waterproof performance of a portion in which a windshield glass and a front pillar are connected by reducing the possibility of penetration of water, which is drained from the windshield glass, into a space between panels by increasing a flow rate of the water and blocking the water from flowing into the panel even when the water penetrates the space between the panels.

An embodiment of the present disclosure can provide a waterproof structure of a front pillar including a side outer panel of which an upper side is disposed at a lower side of a periphery of a windshield glass and which forms an exterior of a side surface of a vehicle, wherein a drainage surface formed at a set, selected, or predetermined angle with respect to a ground is formed on the side outer panel.

A front pillar outer lower reinforce coupled to the side outer panel can be provided on a lower side of the side outer panel, and an inclined surface in surface contact with the drainage surface can be formed on the front pillar outer lower reinforce.

The side outer panel and the front pillar outer lower reinforce can be spaced apart below the drainage surface and the inclined surface.

An upper end of the side outer panel can underlap the windshield glass by a set, selected, or predetermined length in a width direction of the vehicle.

An upper end of the front pillar outer lower reinforce can underlap the windshield glass in greater length than the upper end of the side outer panel.

A front pillar outer lower reinforce coupled to the side outer panel can be provided on a lower side of the side outer panel, a seating surface on which a first flange formed at a front end of the side outer panel can be seated and can be formed on the front pillar outer lower reinforce, and a front end of the drainage surface can be located at a front side in a lengthwise direction of the vehicle further than the seating surface.

The drainage surface can be protrusively located at the front side in the lengthwise direction of the vehicle further than the first flange.

The drainage surface can be located above the first flange.

The waterproof structure of the front pillar can further include a cowl side upper outer panel of which a side end can be coupled between the side outer panel and the front pillar outer lower reinforce, wherein an upper end of the cowl side upper outer panel can be formed to be inclined upward.

An inflow blocking portion can be formed to be inclined upward toward a rear side in the lengthwise direction of the vehicle and can be formed at an upper end of a side surface of the cowl side upper outer panel.

A second flange seated on the seating surface can be formed on the front pillar outer lower reinforce and can be formed at a side end of the cowl side upper outer panel, and the inflow blocking portion can be formed at an upper end of the second flange.

A first flange formed at a front end of the side outer panel can be coupled to an upper side of the second flange.

The inflow blocking portion can be located at a bottom surface of the side outer panel.

The inflow blocking portion can be located below the drainage surface and the inclined surface.

A waterproof structure of a front pillar, can include: a side outer panel that forms an exterior of a side surface of a vehicle; and a front pillar outer lower reinforce coupled to the side outer panel, wherein the side outer panel is formed with, preferably, a flat drainage surface in a predetermined length at a set, selected, or predetermined angle with respect to a ground; and wherein the front pillar outer lower reinforce is formed with an inclined surface to be in contact with the drainage surface of the side outer panel.

The drainage surface can be protrusively located at the front side in the lengthwise direction of the vehicle further than a first flange formed at a front end of the side outer panel.

The front pillar outer lower reinforce can be formed with a seating surface on which the first flange is seated, and wherein a front end of the drainage surface can be located at a front side in a lengthwise direction of the vehicle further than the seating surface to form an overhang.

A cowl side upper outer panel can have a side end coupled between the side outer panel and the front pillar outer lower reinforce.

An upper end of the cowl side upper outer panel can be inclined upward to form an inflow blocking portion.

The inflow blocking portion can be located below the drainage surface and the inclined surface

According to a waterproof structure embodiment of the front pillar of the present disclosure having the above configuration, because the upper end of the side outer panel can be formed to have an inclined surface with a set, selected, or predetermined angle, the water drained from the windshield glass can quickly flow downward, thereby reducing the possibility of penetration of the water into the space between the panels.

Because the front pillar outer lower reinforce can be assembled in surface contact with the bottom surface of the side outer panel, it can be possible to block the water from flowing into the space between the side outer panel and the front pillar outer lower reinforce.

By locating the flange of the side outer panel at the front of the vehicle further than the seating surface of the front pillar outer lower reinforce, it can be possible to prevent the water flowing to the front end of the side outer panel from penetrating the space between the side outer panel and the front pillar outer lower reinforce.

By forming the upper end of the side surface of the cowl side upper outer panel to be inclined upward, it can be possible to block the water from flowing along the upper end of the side surface of the cowl side upper outer panel even when the water is introduced.

### BRIEF DESCRIPTION OF THE DRAWINGS

FIG. 1 is a perspective view illustrating a portion in which a windshield glass and a front pillar are connected in a vehicle.

FIG. 2 is a cutout perspective view of portion A in FIG. 1.

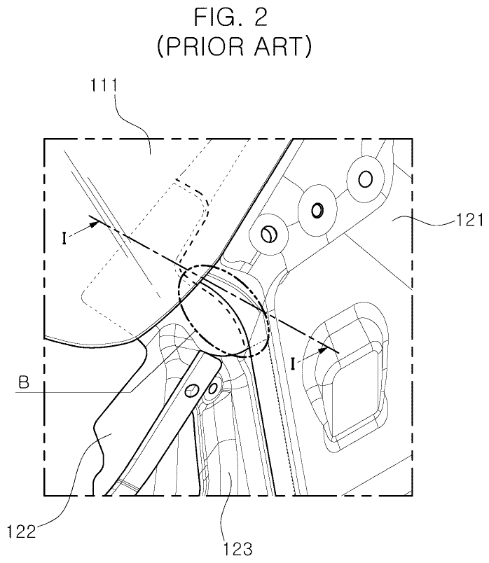

FIG. 3 is a cross-sectional view along line I-I in FIG. 2.

FIG. 4 is a cutout perspective view illustrating a portion to which a waterproof structure of a front pillar is applied according to an embodiment of the present disclosure.

FIG. 5 is a cross-sectional view along line II-II in FIG. 4.

FIG. 6 is an exploded perspective view illustrating an arrangement relationship of a side outer panel, a front pillar outer lower reinforce, and a cowl side upper outer panel that constitute a side of a vehicle in a waterproof structure of a front pillar according to an embodiment of the present disclosure.

FIG. 7 is a schematic view illustrating a state in which a backflow of water can be prevented from an upper end of a side surface of a cowl side upper outer panel for a watertight structure of a front pillar according to an embodiment of the present disclosure.

FIG. 8 is a perspective view illustrating an arrangement relationship of the side outer panel constituting the side of the vehicle and the front pillar outer lower reinforce in a watertight structure of a front pillar according to an embodiment of the present disclosure.

### DETAILED DESCRIPTION OF ILLUSTRATIVE EMBODIMENTS

Hereinafter, a waterproof structure of a front pillar according to an example embodiment of the present disclosure will be described in detail with reference to the accompanying drawings.

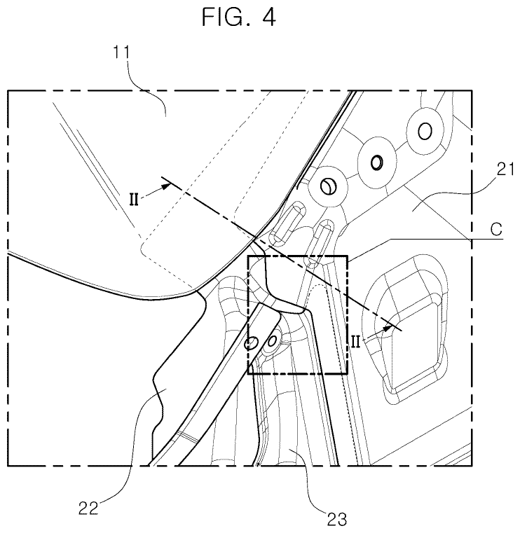

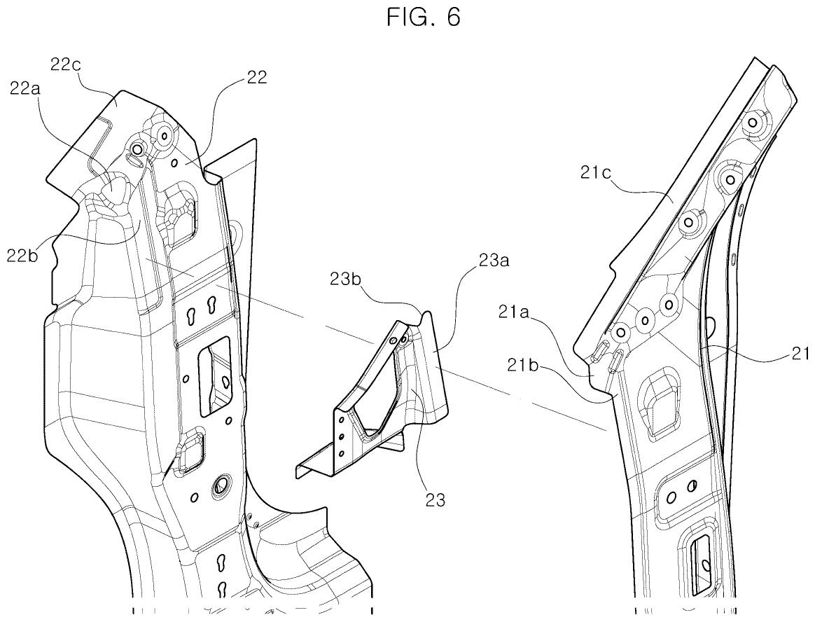

A watertight structure of a front pillar according to an embodiment of the present disclosure is illustrated in FIGS. 4 to 8.

A watertight structure of the front pillar according to an embodiment of the present disclosure can include a side outer panel 21 of which an upper side is disposed at a lower side of the circumference of a windshield glass 11 and which forms an exterior of a side surface of a vehicle, and the side outer panel 21 can have a drainage surface 21a formed at a set, selected, or predetermined angle with respect to the ground.

The windshield glass 11 can be installed in front of a cabin of the vehicle so that occupants of the vehicle may look forward.

The side outer panel 21 can support the lower side of the circumference of the windshield glass 11. An upper end of the side outer panel 21 can be located under the windshield glass 11 and supports the lower side of the circumference of the windshield glass 11 by a glass joint 21c joined to a bottom surface of the windshield glass 11.

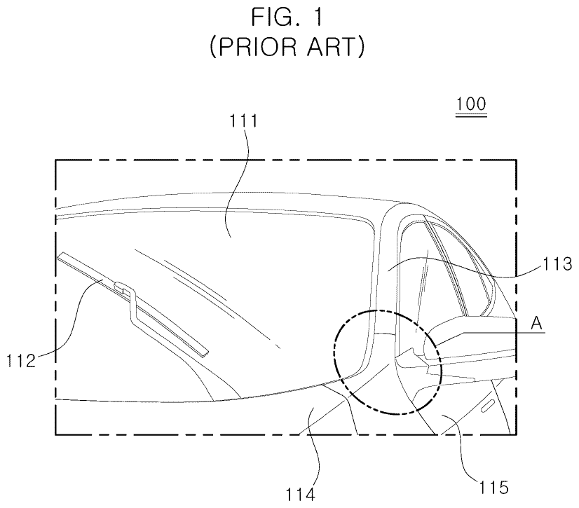

A front pillar outer panel (see, e.g., front pillar outer panel 113 in FIG. 1) can be coupled to the side outer panel 21 along side surfaces of the windshield glass 11 to form a front pillar of the vehicle.

The side outer panel 21 can extend from the side surface of the vehicle toward the ground to form an exterior of the side surface of the vehicle.

A drainage surface 21a can be formed at a set, selected, or predetermined angle with respect to the ground on the side outer panel 21. The side outer panel 21 can have a surface facing the glass joint 21c and a portion extending toward the ground that face different directions and can be connected through the drainage surface 21a.

In particular, the drainage surface 21a can be formed as a flat surface having set, selected, or predetermined inclination with respect to the ground.

A front pillar outer lower reinforce 22 can be coupled to the side outer panel 21 under the side outer panel 21. The front pillar outer lower reinforce 22 can be coupled to the front pillar outer panel along with the side outer panel 21 to form the front pillar of the vehicle.

The front pillar outer lower reinforce 22 can have a glass support 22c formed at an upper end thereof to support the lower side of the circumference of the windshield glass 11. Because the front pillar outer lower reinforce 22 can be coupled to the lower side of the side outer panel 21, the glass support 22c can be also coupled to a lower side of the glass joint 21c. The lower side of the side outer panel 21 can be one of sections in which a paint sealer is not easily coated.

The glass joint 21c formed at the upper end of the side outer panel 21 can underlap the windshield glass 11 by a set, selected, or predetermined length in a width direction of the vehicle. Because the upper side of the side outer panel 21 may be coated with the paint sealer, the upper end of the side outer panel 21 and the windshield glass 11, that is, the glass joint 21c and the windshield glass 11 can overlap each other, and the overlapping portion can be coated with the paint sealer.

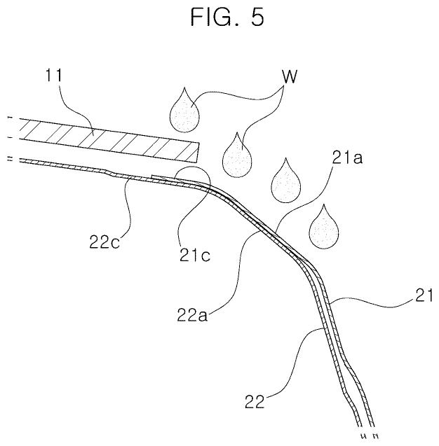

The glass support 22c can be formed at the upper end of the front pillar outer lower reinforce 22 and can also underlap the windshield glass 11 by a set, selected, or predetermined length in the width direction of the vehicle. An upper side of the front pillar outer lower reinforce 22 can be also a section that may be coated with the paint sealer. Accordingly, the upper end of the front pillar outer lower reinforce 22 and the windshield glass 11, that is, the glass support 22c and the windshield glass 11 can overlap each other so that the paint sealer is coated. In this case, an end portion of the glass support 22c can be located inside the windshield glass 11 further than the glass joint 21c. That is, as illustrated in FIG. 5, the glass support 22c of the front pillar outer lower reinforce 22 can further underlap the windshield glass 11 than the glass joint 21c of the side outer panel 21. This can be to secure a space in which the space between the side outer panel 21 and the front pillar outer lower reinforce 22 is coated with the paint sealer.

To prevent water drained from the windshield glass 11 from flowing into the space between the side outer panel 21 and the front pillar outer lower reinforce 22, an inclined surface 22a can be in contact with the drainage surface 21a and can be formed on the front pillar outer lower reinforce 22. The inclined surface 22a can come into surface contact in a set, selected, or predetermined length with the bottom surface of the drainage surface 21a.

By forming the same inclination angles of the drainage surface 21a and the inclined surface 22a, the drainage surface 21a and the inclined surface 22a can come into surface contact with each other according to the coupling of the side outer panel 21 and the front pillar outer lower reinforce 22.

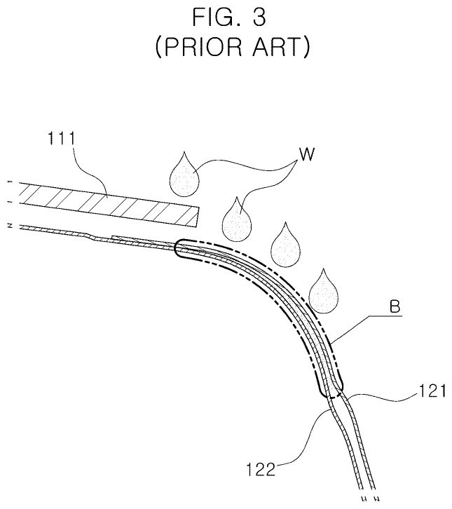

Even when water drop (W) or raindrop drained from the windshield glass 11 flows into the upper side of the side outer panel 21, as shown in FIG. 5, the possibility of penetration of water can be reduced because the water can pass through the drainage surface 21a at a higher speed (e.g., as compared with FIG. 3).

In particular, because the drainage surface 21a and the inclined surface 22a come into contact with each other, it can be possible to prevent water from penetrating the space therebetween. Because the drainage surface 21a and the inclined surface 22a are each inclined but are formed as a flat surface that can be easily processed, a space in which water may penetrate is not formed between the drainage surface 21a and the inclined surface 22a due to processing errors or assembly errors, thereby preventing water from penetrating the space between the side outer panel 21 and the front pillar outer lower reinforce 22.

The side outer panel 21 and the front pillar outer lower reinforce 22 can be spaced apart from each other below the drainage surface 21a and the inclined surface 22a. As illustrated in FIG. 5, the side outer panel 21 and the front pillar outer lower reinforce 22 can be spaced apart below the drainage surface 21a and the inclined surface 22a to form the body of the vehicle.

When the side outer panel 21 and the front pillar outer lower reinforce 22 are coupled, to prevent water that has passed through the drainage surface 21a from flowing into the side outer panel 21 and the front pillar outer lower reinforce 22, the front end of the drainage surface 21a can be located at a front side in a lengthwise direction of the vehicle further than the seating surface 22b formed on the front pillar outer lower reinforce 22.

When the side outer panel 21 and the front pillar outer lower reinforce 22 are coupled, a side edge of the cowl side upper outer panel 23 can be located between the side outer panel 21 and the front pillar outer lower reinforce 22 so that the side outer panel 21, the front pillar outer lower reinforce 22, and the cowl side upper outer panel 23 can be coupled together.

The seating surface 22b can be formed on the front pillar outer lower reinforce 22, and the seating surface 22b can be seated on a second flange 23a formed on the cowl side upper outer panel 23 and a first flange 21b formed on the side outer panel 21.

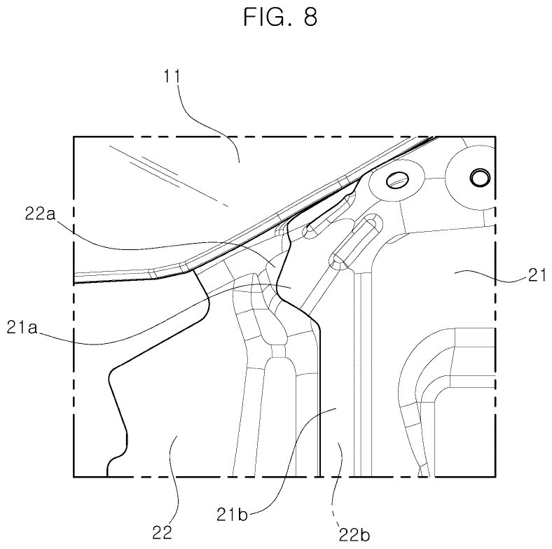

As an additional structure for preventing penetration of water, as illustrated in FIG. 8, the front end of the drainage surface 21a can be located at the front of the vehicle further than the first flange 21b or the seating surface 22b. FIG. 8 illustrates a coupling relationship between the side outer panel 21 and the front pillar outer lower reinforce 22 excluding the cowl side upper outer panel 23 and illustrates that the front end of the drainage surface 21a can be located at the front of the vehicle further than the seating surface 22b. Because the lower side of the side outer panel 21 can be a section in which the paint sealer is not easily coated, it can be possible to structurally prevent penetration of water.

The side outer panel 21 can have the first flange 21b seated on the seating surface 22b at the front end of the vehicle under the drainage surface 21a.

In this case, the drainage surface 21a can be located at the front side in the lengthwise direction of the vehicle further than the first flange 21b, protruding to form an overhang or an eaves structure. In other words, when the drainage surface 21a is protrusively located in front of the first flange 21b, the drainage surface 21a can be located at the front side in the lengthwise direction of the vehicle further than the seating surface 22b.

Accordingly, the water flowing along the drainage surface 21a does not flow to the seating surface 22b when falling from the drainage surface 21a, but falls in front of the seating surface 22b. Accordingly, the water that has passed through the drainage surface 21a can be prevented from flowing into the space between the side outer panel 21 and the front pillar outer lower reinforce 22 below the drainage surface 21a.

A shape for preventing the flow of the introduced water can be also applied to the cowl side upper outer panel 23.

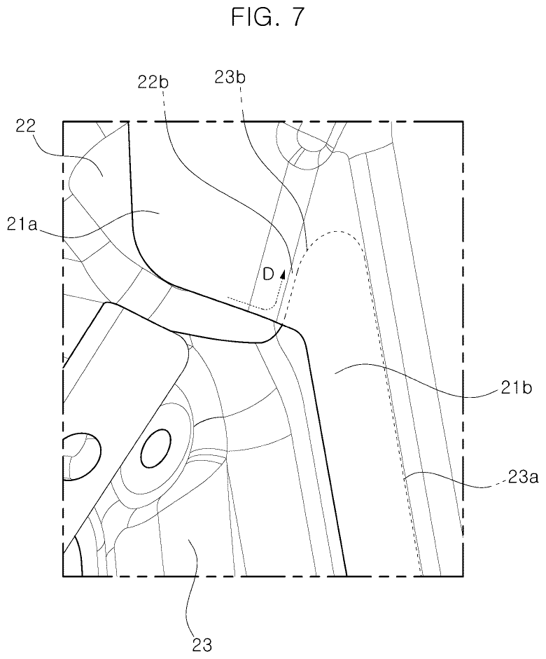

That is, an upper end of the cowl side upper outer panel 23 can be inclined upward to form an inflow blocking portion 23b, as shown in the dotted line in FIG. 7, thereby preventing the water from flowing into a direction of an arrow D due to an inclined structure, i.e., the inflow blocking portion 23b formed at the upper end of the cowl side upper outer panel 23 even when the water flows into the space between the side outer panel 21 and the front pillar outer lower reinforce 22.

The inflow blocking portion 23b that suppresses the flow of the water can be formed at the upper end of the side surface of the cowl side upper outer panel 23. In addition to the above structure, the inflow blocking portion 23b can be formed on the cowl side upper outer panel 23, thereby securely preventing the inflow of water into the vehicle.

The second flange 23a seated on the seating surface 22b can be formed on the cowl side upper outer panel 23 in a height direction of the vehicle, and when the side outer panel 21, the front pillar outer lower reinforce 22, and the cowl side upper outer panel 23 are coupled, the second flange 23a can be located between the seating surface 22b and the first flange 21b and coupled.

The inflow blocking portion 23b can be formed at an upper end of the second flange 23a to be inclined upward toward the rear side in the lengthwise direction of the vehicle. Accordingly, as illustrated in FIG. 7, even when water flows into the inflow blocking portion 23b, the water can be prevented from flowing to the rear side in the lengthwise direction of the vehicle by the inflow blocking portion 23b.

Because the inflow blocking portion 23b can be lower than the drainage surface 21a and located on the bottom surface of the side outer panel 21, some of the water that has passed through the drainage surface 21a may be introduced through the space between the side outer panel 21 and the front pillar outer lower reinforce 22. However, the water can no longer flow due to the inflow blocking portion 23b inclined upward toward the rear side in the lengthwise direction of the vehicle.

In this way, the waterproof structure of the front pillar according to an embodiment of the present disclosure can primarily increase a rate of the water flowing due to the drainage surface 21a and the inclined surface 22a, thereby reducing the time for the water to remain to reduce the probability of penetration of water.

Thereafter, the water that has passed through the drainage surface 21a can fall in front of the seating surface 22b, thereby suppressing the water from flowing into the space between the side outer panel 21 and the front pillar outer lower reinforce 22.

Lastly, even when the water flows into the space between the side outer panel 21 and the front pillar outer lower reinforce 22, the water can be prevented from flowing further due to the inflow blocking portion 23b, thereby preventing water from flowing into the space between the side outer panel 21 and the front pillar outer lower reinforce 22.

What is claimed is:

1. A front pillar structure comprising a side outer panel, wherein the side outer panel comprises:
a side-outer-panel upper side configured to be disposed at a windshield-glass lower side of a periphery of a windshield glass; and
a drainage surface having a first angle with respect to a ground at the side-outer-panel upper side of the side outer panel and configured to be adjacent the periphery of the windshield glass.

2. The structure of claim 1, further comprising a front pillar outer lower reinforce coupled to the side outer panel on a side-outer-panel lower side of the side outer panel, and wherein the front pillar outer lower reinforce comprises
an inclined surface in surface contact with the drainage surface of the side outer panel such that the inclined surface underlaps the drainage surface.

3. The structure of claim 2, wherein the side outer panel and the front pillar outer lower reinforce are spaced apart below the drainage surface and the inclined surface.

4. The structure of claim 2, wherein a side-outer-panel upper end of the side outer panel is configured to underlap the windshield glass by a first length in a width direction of a vehicle.

5. The structure of claim 4, wherein a front-pillar-outer-lower-reinforce upper end of the front pillar outer lower reinforce is configured to underlap the windshield glass by a second length, wherein the second length is greater than the first length.

6. The structure of claim 1, further comprising a front pillar outer lower reinforce coupled to the side outer panel on a side-outer-panel lower side of the side outer panel, wherein the front pillar outer lower reinforce comprises a seating surface;
wherein the side outer panel further comprises a first flange at a side-outer-panel front end of the side outer panel, wherein the first flange is seated on the seating surface of the front pillar outer lower reinforce; and
wherein a flat-drainage-surface front end of the drainage surface is located more forward in a lengthwise direction of a vehicle than the seating surface.

7. The structure of claim 6, wherein the flat-drainage-surface front end is protrusively located more forward in the lengthwise direction of the vehicle than the first flange.

8. The structure of claim 7, wherein the drainage surface is flat and located above the first flange.

9. The structure of claim 2, further comprising a cowl side upper outer panel, wherein the cowl side upper outer panel comprises a cowl-side-upper-outer-panel side end and a cowl-side-upper-outer-panel upper end,
wherein the cowl-side-upper-outer-panel side end is coupled between the side outer panel and the front pillar outer lower reinforce, and
wherein the cowl-side-upper-outer-panel upper end is inclined upward.

10. The structure of claim 9, wherein the cowl-side-upper-outer-panel upper end comprises an inflow blocking portion inclined upward and rearward in a lengthwise direction of a vehicle.

11. The structure of claim 10, wherein the front pillar outer lower reinforce comprises a seating surface;
wherein the cowl side upper outer panel comprises a second flange seated on the seating surface of the front pillar outer lower reinforce; and
wherein the inflow blocking portion is at a second-flange upper end of the second flange.

12. The structure of claim 11, wherein the side outer panel further comprises a first flange at a side-outer-panel front end of the side outer panel, and wherein the first flange is coupled to the second flange.

13. The structure of claim 10, wherein the inflow blocking portion is located at a bottom surface of the side outer panel.

14. The structure of claim 13, wherein the inflow blocking portion is located below the drainage surface and the inclined surface.

15. A front pillar structure comprising:
a side outer panel, wherein the side outer panel comprises a flat drainage surface with a first length at a first angle with respect to a ground; and
a front pillar outer lower reinforce coupled to the side outer panel,
wherein the front pillar outer lower reinforce comprises an inclined surface in contact with the flat drainage surface of the side outer panel.

16. The structure of claim 15, wherein the side outer panel comprises a first flange at a side-outer-panel front end of the side outer panel, and wherein a flat-drainage-surface front end of the flat drainage surface is protrusively located more forward in a lengthwise direction of a vehicle than the first flange.

17. The structure of claim 16, wherein the front pillar outer lower reinforce comprises a seating surface on which the first flange is seated, and
wherein the flat-drainage-surface front end of the flat drainage surface is located more forward in the lengthwise direction of the vehicle than the seating surface to provide an overhang.

18. The structure of claim 15, further comprising a cowl side upper outer panel, wherein the cowl side upper outer panel comprises a cowl-side-upper-outer-panel side end coupled between the side outer panel and the front pillar outer lower reinforce.

19. The structure of claim 18, wherein an upper end of the cowl side upper outer panel is inclined upward to provide an inflow blocking portion.

20. The structure of claim 19, wherein the inflow blocking portion is located below the flat drainage surface and the inclined surface.
